(19) United States
(12) Patent Application Publication
(10) Pub. No.: US 2009/0194372 A1
(43) Pub. Date: Aug. 6, 2009

(54) Hitch attachable no skid emergency brake

(76) Inventor: Zoltan Egeresi, Santa Cruz, CA (US)

Correspondence Address: ZOLTAN EGERESI, 5500 COAST Rd., SANTA CRUZ, CA, 95060, US

(21) Appl. No.: 12/012,457

(22) Filed: Feb. 4, 2008

(51) Int. Cl. B60T 1/14

(52) U.S. Cl. 188/5

(57) ABSTRACT

This invention creates a novel way to stop a vehicle on an icy, snowy or wet surface when normal tire tractions can not do it, and it is adoptable to any vehicle with a hitch. The emergency brake system is a pivotable metal piece, which makes hard contact with the road surface when activated by a winch. The winch pulls up the leading end of the brake bar forcing the other end to make a hard surface contact to scrape the road. Brake rod is attachable to the hitch, height is adjustable for cars, trucks, SUV-s. Since the emergency brake is centered and it is in the rear of the vehicle, it keeps the vehicle straight and balanced as the speed is decreased on any slippery surface. Installation or removal is quick, needs only safety pin insertion into the hitch and quick electrical connection for heavy current.

### CROSS-REFERENCE TO RELATED APPLICATIONS

Some prior art inventions have come up with some specific solutions for ground engaging emergency brake systems.

Boros in U.S. Pat. No. 6,401,876 Jun. 11, 2002 is to prevent trucks jackknifing. It uses a pneumatically energized skids contacting and scraping the ground.

Lim Hwee Beng U.S. Pat. No. 6,220,397 on Apr. 24, 2001 uses an anti ice skidding apparatus, metal wheels engaging with the icy surface to achieve no skidding friction to stop.

Juntain Liu U.S. Pat. No. 5,638,923 on Jun. 17, 1997 uses a hydraulic booster for a metal spike to contact the road surface called the snow brake working parallel with the regular brakes. These invention requires special costly installation and customization.

R. McMillen in U.S. Pat. No. 4,317,507 on Mar. 2, 1982 is anything but practical, uses vacuum hosing structure and anchoring device for braking purposes.

P. Howell's U.S. Pat. No. 3,799,293 uses a skate like slider activated by explosive bolt in case of panic stop.

Current US class: 188/5, 188/6

No federal research found was used for developing this invention.

### BACKGROUND OF THE INVENTION

In cold climates in winter times when road is slippery, icy or snow covered, in case of emergency sometimes it is difficult or next to impossible to stop fast. Road conditions can change quickly, black ice, freezing rain, fog, snow storms can turn road conditions to a very dangerous level in a very short time.

Many multi car accidents happen all the time, even at slow speeds. Standing vehicles, trucks can be blown by strong wind on icy road when tires can not even provide the minimal friction for stability. One prior art invention used surface grabbing devices for emergency brake, they were vehicle frame attachable on two sides requiring special installations. Due to the fact that they used two sided braking, braking frictions would never be the same on both side, uneven surface conditions would create uneven traction, friction, therefore spin outs are almost guaranteed.

My invention uses a universally adopted rear end vehicle hitch for easy installation. Since the hitch is centrally located, the emergency braking rod makes contact in the center of the vehicle, a chance for spin out is almost non existent and my invention is adoptable to any hitch. The winch in this invention is bi-directional and remote controlled, requiring only heavy motor wiring, hitch mounting is using an adjustable bracket, pivoting braking rod is supported by a spring for keeping it in a normal position. action would frame

### BRIEF SUMMARY OF THE INVENTION

This rear hitch mounted no skid emergency brake system is attached with a mounting bracket and slides into the hitch receptacle when road conditions may require. The system's main advantage is that it provide fast and safe practically no skidding braking action due to the fact, that it uses one centrally located surface scraping braking rod on icy or snow covered roads. Emergency stopping is activated by the UP switch, reset by the DOWN command on remote control. It is easily attachable to any vehicle using a universal hitch what became more of a standard on most vehicles.

### BRIEF DESCRIPTION OF THE DRAWINGS

FIG. 1 on Sheet 1 shows the side view of the invention attached to a van's hitch. Emergency brake bar is disengaged.

On sheet 2 FIG. 2 shows the rear view of the invention with emergency brake bar in the engaged, braking position scraping the surface.

### DETAILED DESCRIPTION OF THE DRAWINGS

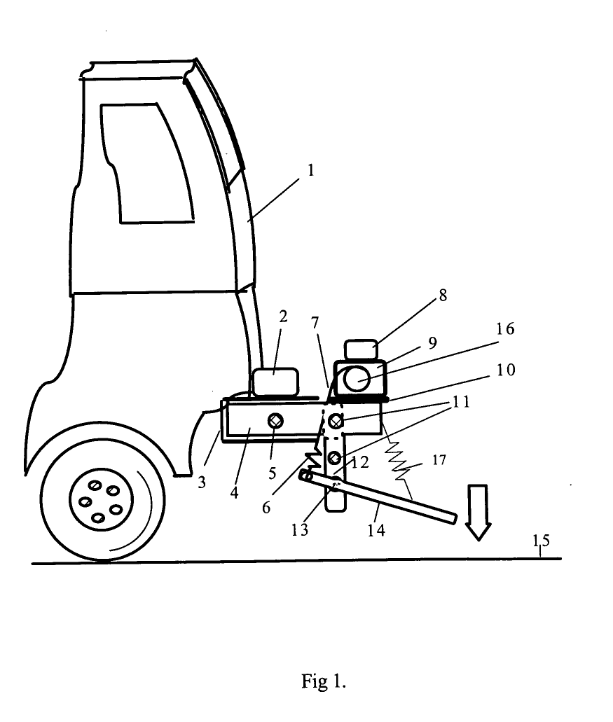

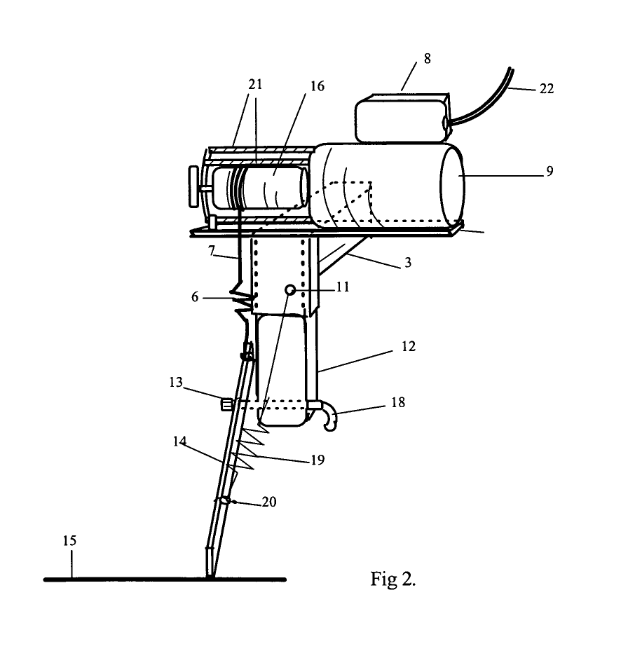

On sheet one of two FIG. 1 shows a Hitch Attached No Skid Emergency Brake system. Vehicle (1) has the attached hitch (3) installed to the rear of the car body just below bumper (2). Adjustable horizontal (4) hitch insert is held into position by safety pin (5), vertical adjustable hitch insert (12) is held by safety pin (11). On the extended portion of the horizontal hitch (4) is the winch base plate (10) secured by bolts or just welded together. On this plate the winch (9) is positioned, that the cable (7) rolls up to the winch drum (16) is forward and connects with a heavy duty short spring with a hook (6) to the surface scraping brake rod (14). The brake rod (14) is pivoted by the safety pin (13) connecting to the lower end of the vertical hitch. In normal inactive position spring (17) holds the brake rod away from the surface preventing any scraping. When the emergency brake is remotely activated, control circuit inside box (8) energizes the motor, it starts pulling in the cord and lifts up the front end of the brake bar (14) and applies a positive braking pressure at the rear end of the brake bar by scraping the snowy, or icy surface (15) enabling the vehicle to come to a very quick controlled stop. Since the location of the bracing rod being in the center rear of the vehicle, this invention provides a great anti skidding stability and very short braking distance. This braking distance depends on the power of the winch, length of braking bar, weight of vehicle and actual surface of the road or not using the front lifting spring.

On sheet 2 FIG. 2. shows the rear view of the Hitch Attachable No Skid Emergency Brake with the brake bar (14) activated, engaging the pavement (15) for braking purposes. The brake bar is attached to the lower end of the vertical hitch (12) with safety pin (18) and nut (13). Electric power cable (22) connects to the remote control box (8).

What is claimed is:

1. An Emergency Hitch Attachable Vehicle Braking System comprising of;
A bi-directional winch or electric motor capable to position a pivotable solid material, preferably a metal brake rod herein called the emergency brake bar into an emergency braking position;
an activating switch wired or radio controlled capable to control motor motion to move the brake rod UP or DOWN with a quick connect electric power wiring;
this invention further comprising of at least a two-piece prior art adjustable bracket assembly, hitch where the brake rod is connected to the lower end of the vertical hitch with a pivotable pin and a nut to hold the brake bar on the pin, a bracket or plate nuts and bolt to secure and hold the motor in a stable position;
a heavy duty flexible cable or solid rigid material attached to front end of the emergency brake bar as it is described above to the winch or motor to be able to pull up the forward end of the brake bar;
the brake bar further has at least two springs, one optional heavy duty at the lifting end and one lower duty at the rear end to keep the brake rod away from the road surface during none emergency, normal condition.
Where:
The above mentioned emergency brake bar may be activated by cable in a winch configuration, manually with cables, motor with prior art type rack and pinion assembly, worm gear type for motion transfer, by pneumatically or by pressurized fluid system to engage the brake road to the road surface by scraping action, creating strong friction on slippery road surface to bring the vehicle to a quick stop;
since the above mentioned components are located at the center rear end of the vehicle it assures a no skidding braking.
